(19) United States
(12) Patent Application Publication
(10) Pub. No.: US 2022/0060781 A1
(43) Pub. Date: Feb. 24, 2022

(54) Display Of Video Content On A Sink Device Using Advanced Features

(71) Applicant: HUAWEI TECHNOLOGIES CO., LTD., Shenzhen (CN)

(72) Inventors: Laurence THOMPSON, Plano, TX (US); Jiong HUANG, Plano, TX (US)

(21) Appl. No.: 17/520,531

(22) Filed: Nov. 5, 2021

Related U.S. Application Data
(63) Continuation of application No. PCT/US2019/043762, filed on Jul. 26, 2019.
(60) Provisional application No. 62/844,042, filed on May 6, 2019.

(51) Int. Cl. H04N 21/4363; H04N 21/426; H04N 21/44; H04N 21/61

(52) U.S. Cl. CPC H04N 21/43635; H04N 21/6118; H04N 21/44; H04N 21/426

(57) ABSTRACT

The disclosure relates to displaying video content at a sink device that received video content from a source device. In one example implementation, the sink device can receive a signal from the source device to confirm a High-Definition Multimedia Interface (HDMI) cable assembly connection, and the sink device can send extended display identification data (EDID), including one or more data blocks with advanced features, to the source device, via the HDMI cable assembly, indicating the sink device's most advanced features to support displaying of the video content in response to the signal.

### CLAIM FOR PRIORITY

This application is a continuation application under 35 U.S.C. 111(a) of and claims priority to International Application No. PCT/US2019/043762 filed on Jul. 26, 2019, which claims the benefit of priority to U.S. Provisional Application No. 62/844,042, filed May 6, 2019. The entire contents of both applications are hereby incorporated by reference.

### FIELD

The disclosure generally relates to the processing of video data.

### BACKGROUND

Video content is often produced with a vision or goal to provide consumers a new differentiated entertainment experience that delivers a premium expression of creative intent using next generation audio-visual technologies. To be able to present this video content in the intended format, the preferred or defined format (e.g., highest quality format supported by the display device) needs to be provided to the source device providing the video content. If the preferred format is not provided to the source device, the display device (also known as the sink device or video sink) may not properly display the video content in the preferred format automatically, even if such capability exists at the display device. Consequently, there should be a consistent and well defined mechanism to present information from display device to the video source device.

### BRIEF SUMMARY

According to a first aspect of the present disclosure, there is a method of displaying video content, comprising receiving, at a sink device, a signal from a source device to confirm connection of a High-Definition Multimedia Interface (HDMI) cable assembly; and sending extended display identification data (EDID), including one or more data blocks identifying advanced features, to the source device, from the sink device via the HDMI cable assembly, indicating at least the sink device's most advanced features to support displaying of the video content in response to the signal.

Optionally, in any of the preceding claims, the method further comprises receiving the video content from the source device in a format defined by the advanced features; and displaying the video content on a display of the sink device in the format defined by the advanced features.

Optionally, in any of the preceding claims, the advanced features indicate the format to be an ultra-high definition (UHD) specific format.

Optionally, in any of the preceding claims, the source device and the sink device are connected using the cable assembly.

Optionally, in any of the preceding claims, the signal and the video content are received over the HDMI cable assembly.

Optionally, in any of the preceding claims, the sink device is UHDA Specified Reference Mode (UHDA-SRM) compliant.

Optionally, in any of the preceding claims, the source device is at least one of a Blu-ray disc, a digital versatile disc (DVD), a set-top box or an over-the-top box.

Optionally, in any of the preceding claims, the sink device is at least one of a display, a television and a PC monitor.

According to a first aspect of the present disclosure, there is a sink device to display video content, comprising a receiver configured to receive a signal from a source device to confirm connection of a High-Definition Multimedia Interface (HDMI) cable assembly, the signal received on a first line of the HDMI cable assembly; and a transmitter configured to send extended display identification data (EDID), including one or more data blocks identifying advanced features, to the source device, from a second line of the cable assembly, indicating at least the sink device's most advanced features to support displaying of the video content in response to the signal.

Optionally, in any of the preceding claims, the first line of the HDMI cable assembly is a +5V/Hot Plug Detect (HPD) line and the second line of the HDMI cable assembly is a Display Data Channel (DDC) line.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Aspects of the present disclosure are illustrated by way of example and are not limited by the accompanying figures for which like references indicate elements.

FIG. 1A illustrates an example of a coupling between a video sink and a video source.

FIG. 1B illustrates a video system including a video source connected to a video sink with a cable assembly.

FIG. 2 is a high level functional diagram of the source/sink interface for an HDMI or other standard.

FIG. 3 illustrates an embodiment that provides a communication mechanism between a video source and a video sink for implementation of a specified display mode.

FIG. 4 illustrates and example initialization sequence for connection of an HDMI cable assembly.

FIG. 5 illustrates a format for a vendor specific data block.

FIG. 6 illustrates a format for Auxiliary Video Information (AVI) InfoFrame.

FIG. 7A and FIG. 7B are flowcharts to illustrate embodiments of implementing the mechanism for communicating the use of the specified display mode from a video source to video sink.

### DETAILED DESCRIPTION

The present disclosure will now be described with reference to the figures, which in general relate to the processing and transmission of video signals.

Video content is often created with the intention that it will be presented in a particular way, such as would reflect a director's intention for the display of film or cinema content. A television or other display may have a number of different formats and variables in how it processes received content for display, which may or may not include the preferred mode of the content creator. When a display device receives content directly from an over-the-top (OTT) content provider or through a standard audio/video interface, such as HDMI, the content may specify information about the preferred display mode, sometimes referred to as a “UHD Content”. Alternatively, the television or display may enter the “UHD Mode” by internally detecting the presence of UHD characteristics. However, if the display device does not provide the content provider (or source device) with sufficient information (e.g., information that includes the features of the display device) to indicate the preferred mode, the display device may not receive the video content in the highest quality (preferred mode) automatically, i.e. in UHD mode (or some other high quality mode). The following presents techniques to consistently provide or report advanced feature signaling information, such as the display device capabilities, to a content provider (or source device) such that the content provider has knowledge of the display device capabilities without manual effort involved and provides video content to the display device in the preferred mode, particularly where the display device is Ultra-High Definition Alliance (UHDA) compliant.

More specifically, video content may be provided to a television or other display device through multiple paths. A television can receive video content directly through over-air broadcasts, or the television can receive video content directly through a connection to the internet via an OTT from a content provider. A television can also receive video content through a local connection—such as a High Definition Multimedia Interface (HDMI)—from a video source device, such as a Blu-Ray disc player, cable or satellite set-top box, or Internet connected Source device. Prior to video content reaching the television directly, or through an HDMI connection from a video source, the television may report its display capabilities to the video content source provider. The display capabilities may be embedded in data that specifies the display features (e.g., the capability of the television to display in various formats, including the highest quality format). In some instances, the embedded data that specifies the display device's advanced feature capabilities may not be present. In these instances, the video content provided to the television or other display device by the content source provider through an HDMI connection may result in content being displayed in a quality that is less than a preferred Mode and less than the capabilities of the television or display device.

It is understood that the present embodiments of the disclosure may be implemented in many different forms and that scope of the claims should not be construed as being limited to the embodiments set forth herein. Rather, these embodiments are provided so that this disclosure will be thorough and complete and will fully convey the concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

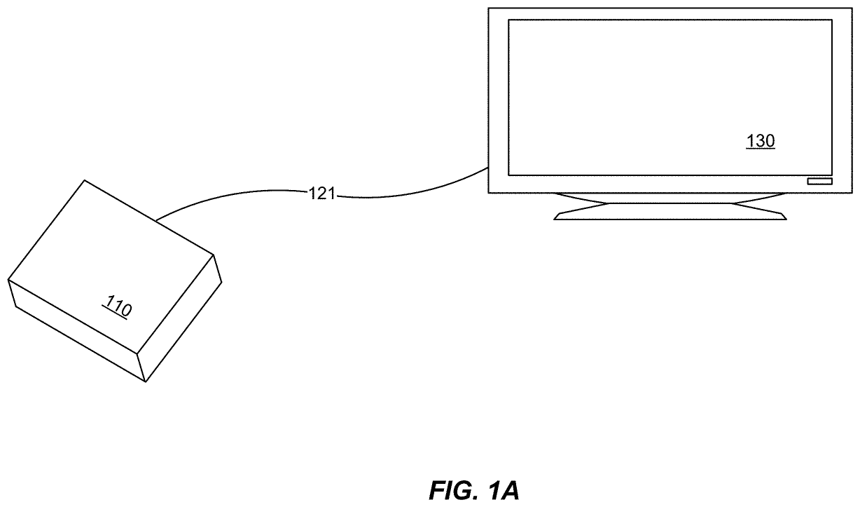

FIG. 1A is illustrates an example of a coupling between a video sink and a video source. A video sink 130 is coupled to the video source 110, for example, through a cable assembly 121, such as an HDMI cable. In the disclosed embodiment, the video sink 130 is a digital television set, for example, having an ultra-high definition (UHD) format and the video source 110 is a set top box that complies with the HDMI standards. The video source 110 may generate video (and audio) having a resolution, for example 4K or 8K. The generated video (and audio) are sent by the video source 110 to the video sink 130 via cable assembly 121. Upon receipt of the video from the video source 110, the video sink 130 may display the video in the designated resolution for the viewing pleasure of a user. While the disclosed embodiment references a set top box and television, it is appreciated that the video source 110 and video sink 130 are not limited to such devices and may be any well-known source or sink device, as described below with reference to FIG. 1B.

In the discussion that follows, and to place the discussion into a more concrete context, the following discussion will primarily refer to the example of the Ultra-High Definition Alliance (UHD-Alliance or UHDA) protocol. The UHDA is a Standards Development Organization (SDO) with the goals of providing consumers with new differentiated entertainments experience that can deliver a premium expression of creative intent using advances in audio-visual technologies. In this regard, UHDA has defined the requirements of UHDA Specified Reference Mode (UHDA-SRM), a.k.a. Director's Mode, or Filmmaker's Mode, for Standard Dynamic Range (SDR) and High Dynamic Range (HDR) Display Devices. The UHDA-SRM specification reflects the advice of content creators regarding their “creative content” and how to recreate those preferred conditions when using consumer displays to reproduce, as closely as possible, that creative intent: The experience that the author intended. UHDA-SRM specifies image processing requirements for the Director's Mode. UHDA-SRM also specifies how Director's Mode is enabled in a display.

To better understand the components and communication between a source device and display (sink) device, FIG. 1 is used to describe an embodiment for some components of a video system. The video system of FIG. 1 includes a video source (or source device) 110 that provides a video signal to a video sink (or sink device) 130. Examples of a video sink 130 are a television, monitor, other display device or end use device, or may be an amplifier or repeater that would in turn act as a video source for a subsequent element in a video system. On the video sink 130, a receiver circuit Sink (receiver) Rx 131 receives the signal form the video source 110, where the Sink Rx 131 can include an equalization circuit and other interface elements for the signal received from the video source 110 over a cable or other connector.

The video source 110 provides the video signal to the video sink 130 from a transmitter circuit Source Tx 119. Some examples of a video source 110 are a set-top box, a DVD, Blu-Ray or other media player, or video camera. The video source can be any system-level product to provide a baseband or uncompressed digital video signal.

In the video source 110, the video signal is provided by the signal provider 111. In the example of the DVD or other media player, the signal provider 111 would read the media to provide the video data/content. In the example of a set-top box or other device that receives the video signal over a cable or other connector, the video signal is received at a receiver circuit or interface for the signal provider 111. For example, in a set-top box embodiment of a video source 110, the set-top box might receive a video signal from a cable provider over a coaxial cable, where the video signal is compressed and encoded according to an MPEG (Moving Picture Experts Group) standard, such as MPEG-4, or other compression algorithm.

As the received video signal will often be compressed, such as with an MPEG-type compression, the stream of received video data can be decompressed at the video decompression block 112 to generate an uncompressed digital video/audio signal. Depending on the embodiment, in some cases (such as a video camera) where video decompression is not needed, the video decompression block 112 need not be included in the video source device 110. The video source 110 can then perform processing on the decompressed stream of video data. For example, in addition to image processing, the video data may be encrypted in some embodiments, formed into packets, have error correction information added, or have other operations performed upon it. Among other processing, this can include functionality to comply with the requirements of an interface standard, such as HDMI, to transmit the video signal to the sink device (e.g., video sink 130) over the cable assembly 121 as performed in the Source Tx 119.

The video signal can be transmitted from the video source 110 to the video sink 130 over a cable assembly 121, of which there are a number of formats such as component video cable, VGA (Video Graphics Array) cables, or HDMI cables. For purposes of discussion, the HDMI cable assembly will be used as the main embodiment. An HDMI cable assembly 121 will be a cable with plugs or connectors 125 and 127 on either end. The plugs 125 and 127 can plug into corresponding sockets, ports or receptacles 123 and 129 to provide video data from the Source Tx 119 to the Sink Rx 131. In a common embodiment, the video data as received at the video source 110 will have the active video (i.e., the pixels of the image to be provided on a television or other display) compressed, but the video data transmitted over the cable assembly 121 to the video sink 130 can have uncompressed or compressed active video portions. For example, the active video may be DSC (Display Stream Compression) compressed, which is a visually lossless low-latency compression algorithm.

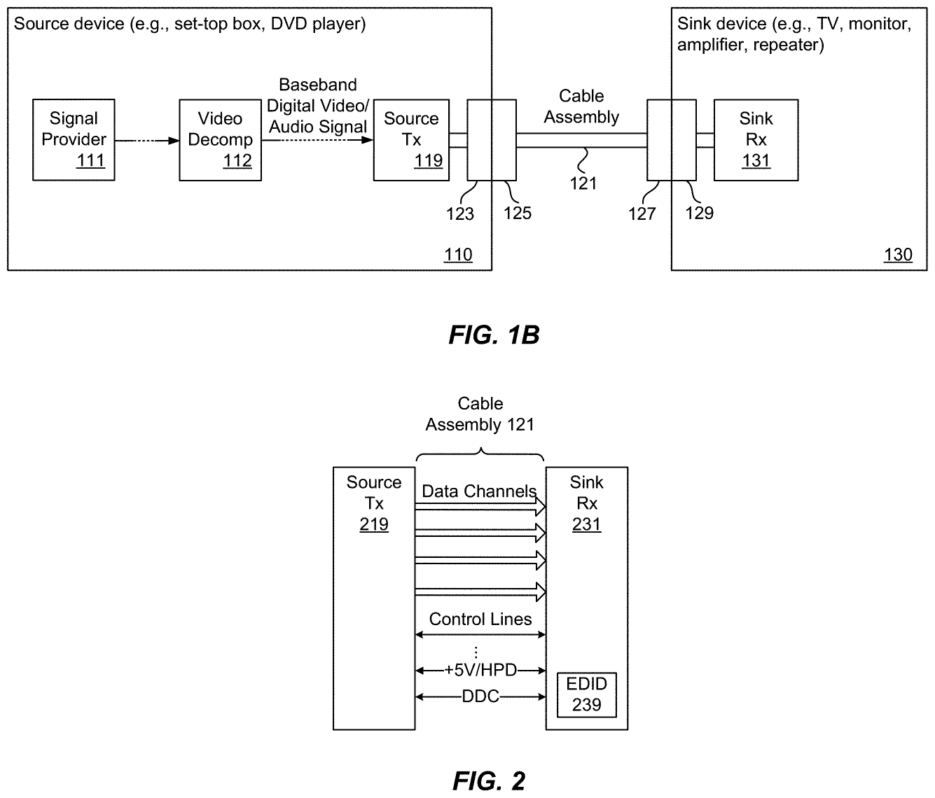

FIG. 2 is a high level functional diagram of the source/sink interface for an HDMI or other standard. HDMI is provided for transmitting digital television audiovisual signals from Source devices, such as Source Tx 219, to Sink devices, such as Sink Rx 231. As appreciated, HDMI may carry high quality multi-channel audio data and all standard and high-definition consumer electronics video formats. HDMI can also carry control, status and data information in both directions. A device that is compliant with the HDMI specification (any version) is interoperable with other compliant devices through the configuration and implementation provided by the specification.

The system includes the Source Tx 219, a cable assembly 121 with signals carried therein (represented by the arrows), and the Sink Rx 231. The video data is transferred over the data channels, where there can be a number of such channels to provide high data transfer rates. As illustrated, there are four data channels. However, other embodiments can have more or fewer data channels. The interface may also be operable in different modes, where less than all of the available data channels are used in some modes if, for example, the interface is operating at a lower data rate or to provide back-compatibility with earlier versions of a standard. In the shown example, a high data rate four lane mode could use all of the provided data channels, while a three lane mode can be provided for back compatibility to an earlier version of a standard by repurposing one of the channels. In some embodiments, the video source on the Source Tx 219 side can configure the link to operate at different bit rates using a fixed rate link. The cable assembly 121 can also have a number of control lines for the exchange of control signals over the source/sink link.

In one embodiment, the cable assembly 121 includes a Hot Plug Detect (HPD) line that recognizes when a Sink Rx 231 is ready for access after being plugged into Source Tx 219 while both are powered on. In one further embodiment, the cable assembly 121 also includes a display data channel (DDC) that is used for configuration and status exchange between the Source TX 219 and the Sink Rx 231. The DDC is used by the Source Tx 219 to read the Sink Rx 231 Extended Display Identification Data (EDID) 239 (or Enhanced EDID (E-EDID)) in order to discover the Sink Rx 231 configuration, parameters and/or capabilities. In another embodiment, the DDC is used by the Sink RX 231 to report the EDID 239 (or E-EDID) configuration, parameters and/or capabilities. In some embodiments, the DDC adds a set of HDMI-specific DDC registers in HDMI Sinks to exchange point-to-point dynamic data between the Source Tx 219 and the Sink Rx 231.

In general, the EDID 239 includes basic information and display parameters, such as manufacturer, serial number, dock and resolution of the display device and is a standard data format defined by the Video Electronics Standards Association (VESA) that is configured to enable the display device to support Plug and Play functionality. The EDID 239 is typically part of the sink interface and may be stored, for example, in internal storage of the display device, such as Read Only Memory (ROM). The EDID 239 also includes data on the display capabilities that the HDMI sink Rx 231 supports for the display of video content on display (e.g. video sink 130).

Some examples of display configurations, parameters and/or capabilities stored in the EDID 239 that can be set in a specified display mode can include: frame rate; dynamic range; color gamut; a transfer function for the display of the video content; and a definition level for the display of the video content. In some embodiments, the specification of one or more of these properties within the frames of video content supplied from the video HDMI source device (video source) 310 to the HDMI sink device (video sink) 330 can serve to specify a display mode for the presentation of video content. For example, a specific frame rate can invoke a specified presentation mode.

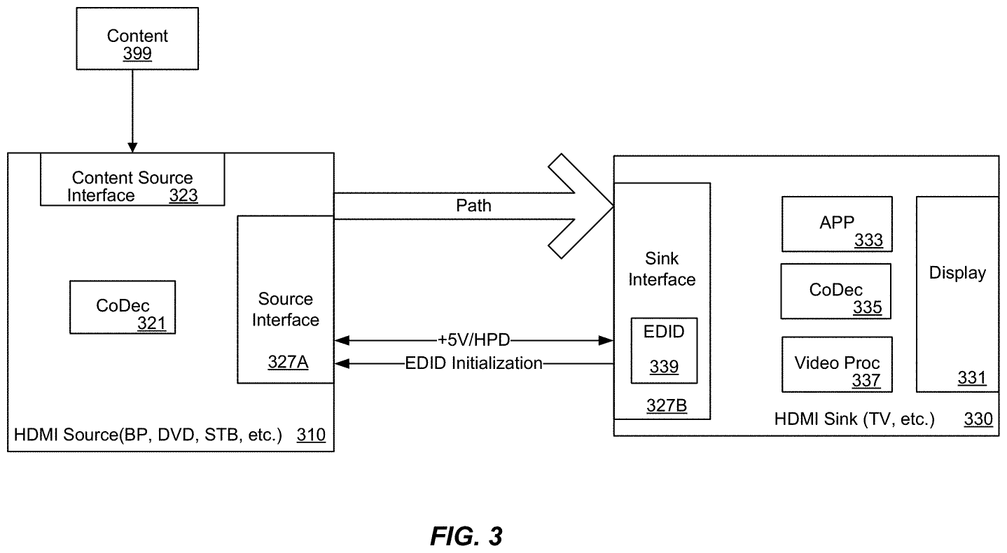

FIG. 3 illustrates an embodiment that provides a communication mechanism between a video source and a video sink for implementation of a UHD display mode. A HDMI sink device 330, for example an HDMI sink, includes a display 331, such as a television screen, for the presentation of video content. One or more applications, represented at APP 333, can run on the HDMI sink device 330 to handle decoding of video content that is specific to a content provider (e.g., Amazon Prime®, Netflix®, or other such services). The video signal can then go to a coder-decoder (CoDec) 335 that can further decode the video signal, such as decompressing video from a Moving Picture Experts Group (MPEG) format, for example. A video processor 337 can perform any processing to be performed on the video content prior to its presentation on display 331. For example, the video processor 337 can perform any processing that would place the video content into a specified format or mode, such as UHD Mode, for its display. The HDMI sink device 330 can perform these functions through software, hardware, firmware, or various combinations of these. For example, the applications of APP 333 and the codec 335 could be implemented through software run on a processing unit and the video processor 337 could be implemented as an application specific integrated circuit (ASIC).

As explained above, many different types of display formats exist, and content being received from the video HDMI source device 310 (in this example, an HDMI source), should match the display mode capabilities of the HDMI sink device 330 such that the user of the HDMI sink device 330 is provided with the best user experience (e.g., the user is provided with the highest resolution). To help ensure that users obtain the best display (and/or audio) experience, a communication protocol can be introduced to make UHD specific EDID features available on UHDA certified and UHDA-SRM compliant HDMI ports. Under this mechanism, the content carrying video source device is made aware of the capability of a connected video sink or display device so that it is able to enforce UHD content delivery with UHDA certified devices automatically.

In one embodiment, when a UHDA certified display device, such as HDMI sink device 330, is connected to an HDMI Source, such as HDMI source device 310, using an HDMI cable, the UHD specific capabilities of the HDMI sink device 330 are sent to the HDMI source device 310, as detailed in the EDID features stored at the HDMI sink device 330. Accordingly, the video source device can deliver video content to the display device such that the UHDA-SRM capable display device can enable the display of a preferred mode, such as UHD Mode, correctly and render UHD content in accordance with the preferred mode.

As depicted in FIG. 3, the HDMI sink device 330 includes a sink interface 327B (in this example, an HDMI interface) and can include elements of sockets, ports or receptacles 129 for connection of an HDMI cable assembly 121 and Sink Rx (e.g. video sink 130) from FIG. 1. During initialization, when a HDMI source device 310, such as a computer host or a game console, is connected to the HDMI sink device 330 (e.g., display device), the +5V/HPD line detects whether the cable, assembly (e.g., HDMI cable) has been connected. The connection process begins when the HDMI source device 310 outputs a +5V signal to the HDMI sink device 330, which causes the HDMI sink device 330 to prepare the EDID 339 in the background. When the EDID 339 is ready (i.e., the advanced features are ready to be fetched by the source device), the sink device 330 sends back a signal to the source device (i.e., asserts the HPD to the source device) via the HPD line. Once the cable assembly has been detected as connected (and powered on), the EDID 339 is read by the HDMI source device 310 to determine the standard and advanced features of the display, such as video formats (e.g., 4K resolution, HDR, BT.2020, Deep Color, etc.), audio formats and lip-sync delays.

In one embodiment, the HDMI sink 330 can provide the EDID 339 to the HDMI source device 310, as indicated by the EDID initialization signal between these devices. A sink device which supports UHDA-SRM (UHDA-SRM compliant) should automatically present advanced audio and video capability that the HDMI sink 330 supports in its EDID 339. In one embodiment, when the HDMI sink device 330 is UHDA-SRM compliant, the HDMI sink device 330 sends data stored in the EDID 339, including one or more of the HDMI Forum-Vendor Specific Data Block (HF-VSDB) and other Data Blocks (e.g. HDR Data Block, Colorimetry Data Block, etc.) to the HDMI source device 310 as a matter of course. These data blocks will include the advanced features such that the HDMI source device 310 will recognize the advanced display (and audio) capabilities of the HDMI sink device 330 and therefore provide the highest quality video content (e.g., UHD) for display. In one embodiment, the EDID 339 and data blocks with advanced features are sent automatically upon connection to the HDMI source device 310 when the HDMI sink device 330 is UHDA compliant device. In one further embodiment, the HDMI sink device 330 may support other standard-based (or recommended) highest quality compliance or guidance for UHD experience. Accordingly, the process and devices herein extend beyond non-UHDA SRM compliancy.

Depending on the embodiment, the HDMI source device 310 can be a Blu-ray disc player (BP), a DVD (digital versatile disc) player, a set-top box (STB) or combination of these and other video sources. The HDMI source device 310 can be as described above with respect to the video source 110 of FIG. 1 and, in the shown embodiment, communicate with the HDMI sink device 330 by way of an HDMI interface, as described above. For purposes of this discussion, the HDMI source device 310 is shown to include content source interface 323 and coder-decoder (CoDec) 321, although other components may be added.

The source interface 327A in this example is an HDMI interface and can include elements of sockets, ports or receptacles 123 for connection of an HDMI cable assembly 121 and Source Tx 119 from FIG. 1. The content source interface 323 can similarly include both a physical interface, such as for the connection of a cable, and also elements to perform some of the processing for received video content, as described with respect to APP 333 of the HDMI sink device 330. The CoDec 321 can perform coding and decoding on video content received from the content source interface 323 and provide the resultant coded/decoded video content to the source interface 327A. The operations performed on the video content by these elements can perform these functions through software instructions executed by a processing unit, hardware such as one or more ASICs, firmware, or various combinations of these.

In one embodiment, the HDMI source device 310 and the HDMI sink device 330 communicate in a CTA-861G and HDMI format.

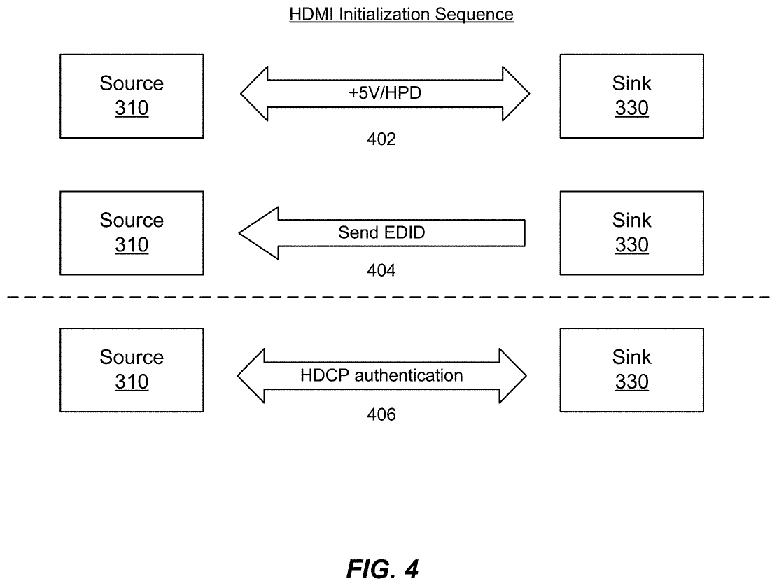

FIG. 4 illustrates and example initialization sequence for connection of an HDMI cable assembly. The sequence, as depicted, is divided into two parts—part one includes steps 402-404, and part two includes step 406. However, it is appreciated that the division of steps is for explanatory purposes only and does not occur during implementation. Part one of the sequence relates to detecting a cable assembly is connected and that EDID is probably conveyed. During initialization, a HDMI source device 310 and HDMI sink device 330 exchange information to determine the highest resolution, correct audio outputs and High-bandwidth Digital Content Protection (HDCP) compliance. As described above, the connection begins when the HDMI source device 310 outputs a +5V signal to the HDMI sink device 330, which sends back a signal to the HDMI source device 310 on the HPD line at step 402. If the HPD is asserted, the HDMI source device 310 will read the capabilities of the HDMI sink device 330. The HDMI sink device 330, which lists its capabilities in the EDID, will automatically send its most advanced feature capabilities to the HDMI source device 310 at step 404, when the HDMI sink device 330 is UHDA compliant. For example, the HDMI sink device 330 will convey acceptable video formats, audio formats, lip-sync delays, etc. such that the most advanced features of the HDMI sink device 330 are exposed (as opposed to being hidden) to the HDMI source device 310. In one embodiment, the most advanced features are the features or feature set that the HDMI sink device 330 supports or is capable of supporting and which provides the HDMI source device 310 and hence, the user of the HDMI source device 330 with the highest quality performance and/or experience. Part two of the sequence relates to the remainder of authenticating the devices. After the EDID is read after being transmitted at step 404, the HDCP authentication process may be completed (the details of which are not relevant for purposes of this discussion).

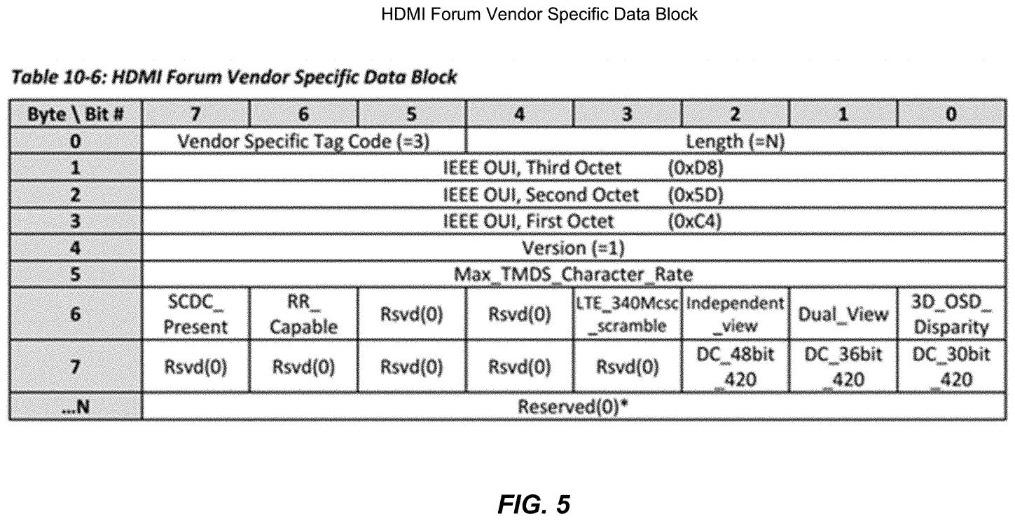

FIG. 5 illustrates a format for a HF-VSDB. The first byte of the block indicates that the block is a Vendor-Specific. Datablock (VSDB), as well as the length of the VSDB. The second, third and fourth bytes contain an IEEE Organizationally Unique Identifier (OUI) assigned to the HDMI Forum (HF). The OUI is used by devices compliant with the HDMI specification to identify the VSDB as the HF-VSDB of FIG. 5. The Length field [5 bits] indicates the total length of the data block, not including this byte, and a minimum value of 7 and a maximum value 31. The field IEEE OUI [3 Bytes] holds the IEEE Organizationally Unique Identifier (OUI) designated to the HF. The field Version [1 Byte] indicates the version number associated with the contents of the HF-VSDB, where sink devices compliant with the Specification are set to a value of 1. The field Max_TMDS_Character_Rate [1 byte] indicates the maximum Transition-Minimized Differential Signaling (TMDS) Character Rate supported. The maximum rate=Max_TMDS_Charater_Rate*5 Mhz. If the sink device does not support TMDS Character Rates>340 Mcsc, then the sink device shall set the field to 0. If the sink device supports TMDS Character Rates>340 Mscs, the sink device shall set Max_TMDS_Charater_Rate appropriately and non-zero.

The Max_TMDS_Charater_Rate field may be set by the sink device to a value below the TMDS Character Rate corresponding to the maximum Pixel clock rate at the maximum color depth. This allows the sink device to support higher color depths at lower resolutions than it can support at higher resolutions.

Accordingly, the HF-VSDB may be used by the HDMI sink device 330 to indicate supported features that have been defined in the HDMI specification. The HF-VSDB may then be read as part of the EDID (during initialization) such that a HDMI source device 310 reads the sink device's supported features (e.g., advanced features). In one embodiment, reading of the HF-VSDB by the HDMI source device 310 is required when the HDMI sink device 330 is UHDA compliant. In this embodiment, the advanced features may be at least the most advanced features available by the sink device.

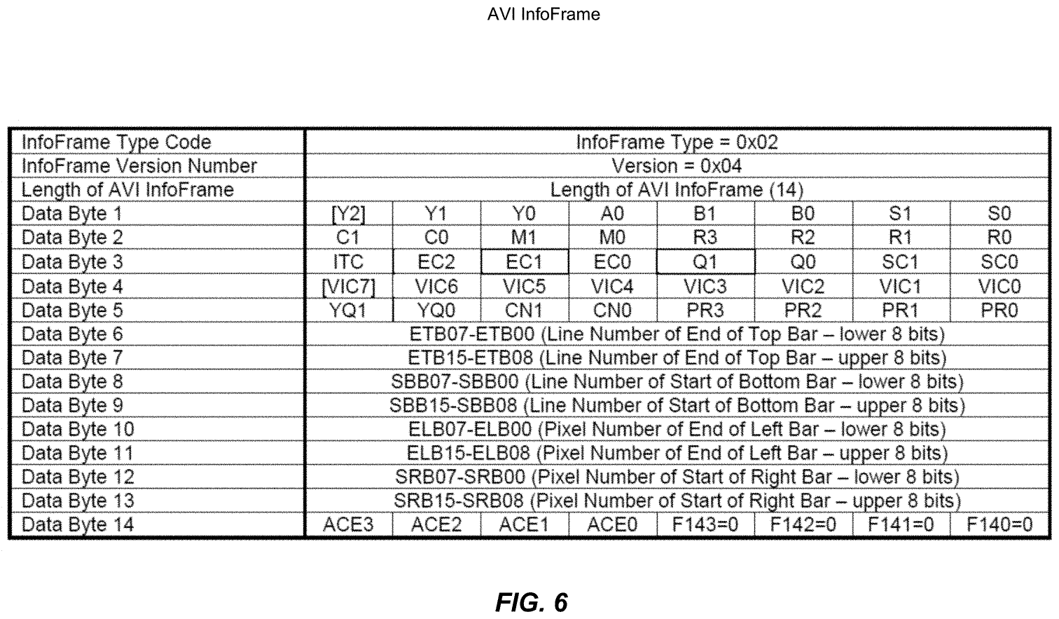

FIG. 6 illustrates a format for an Auxiliary Video Information (AVI) InfoFrame. AVI InfoFrame is defined by the Consumer Technology Association (CTA) and is specified in the standards document CTA-861. This standard is incorporated into HDMI by reference. The AVI InfoFrame has been defined for many years and may be used by millions of HDMI Source devices. If a sink device exposes the advanced features at initialization (as described above), and if the content on the source device is UHD in addition to UHD video transmission, the source device will transport various InfoFrames with the advanced features (e.g. UHD resolution, Deep Color, HDR, BT2020, etc.) set consistent with the content. After receiving these InfoFrames, the sink device will decode the payload and apply the advanced features when displaying the content.

More specifically, the AVI InfoFrames tell the sink device the dynamic configurations of the source device. For example, they include pixel encoding and enhancement support for the video. There also are audio InfoFrames, which describe the details about the audio data formats and rate so the sink device can synchronize itself with the incoming audio data format. A single physical interface is not specified, but any interface that implements InforFrames must use the VESA Enhanced Extended Display Identification Data Standard (VESA E-EDID) for format discovery. This includes, for example, an HDMI interface.

Various aspects of the video stream are identified by the source device to the sink device (in this case HDMI source and sink devices) using an Auxiliary Video information (AVI) InfoFrame. A source device transmits an AVI InfoFrame at least once per two video fields if the Source is capable of transmitting: an AVI InfoFrame, YCBCR pixel encoding, any Colorimetry other than the transmitted video format's default Colorimetry, any xvYCC or future enhanced Colorimetry, any Gamut Metadata packet, or any video format with multiple allowed pixel repetitions.

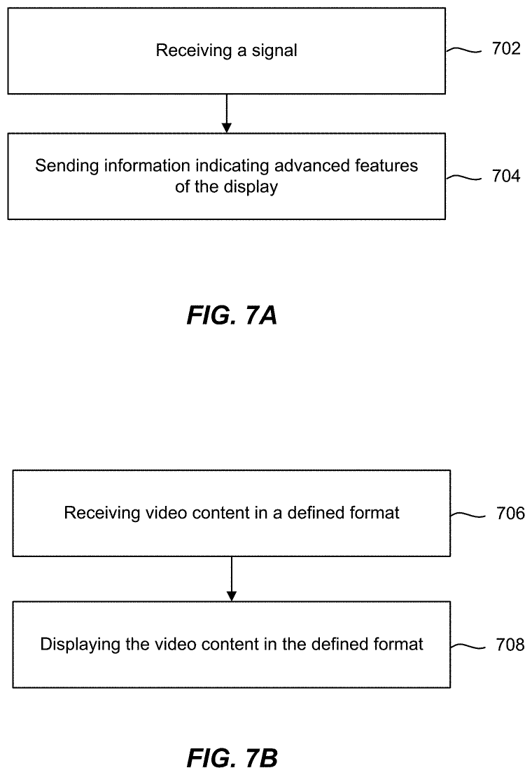

FIGS. 7A and 7B illustrate example flow diagrams of displaying video content in a defined mode. The process may be implemented in accordance with the components depicted in the various figures. In particular, the process is being described, for purposes of discussion, from the perspective of a video display device, such as HDMI sink device 330. However, it is appreciated that other components depicted in the various embodiments may also implement the process.

With reference to FIG. 7A, at step 702, a sink device receives a signal from a source device to confirm that a connection exists between the sink device and the source device. In one embodiment, the connection is an HDMI cable assembly. Other cable assemblies, such as DVI, may also be employed. Once the signal is received, the sink device may confirm that the connection over the HDMI cable assembly, for example using the HPD line, and then send information to the source device at step 704. The information sent to the source device indicates the advanced features of the sink device that support displaying the video content over the HDMI cable assembly. In one embodiment, the information in the EDID is stored in memory of the sink device and is transmitted as a part of step 704.

Turning to FIG. 7B, at step 706, and after the advanced features have been sent to the source device, video content may be received from the source device in the format defined by the advanced features (in the format, such as UHD mode, that is the highest quality for the best user experience). The received video content at the sink device may then be displayed in the defined format in accordance with the advanced features at 708. Since the sink device has expressly provided the most advanced features to the source device, the source device will provide the video content in the format consistent with the advanced features to thereby display the highest quality of video.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application and to enable others of ordinary skill in the art to understand the disclosure with various modifications as are suited to the particular use contemplated.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims. In the claims, the word “comprising” does not exclude other elements or steps, and the indefinite article “a” or “an” does not exclude a plurality.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of displaying video content by a sink device, comprising:
receiving a signal that includes one or more data blocks from a source device via a High-Definition Multimedia Interface (HDMI) cable assembly; and
sending extended display identification data (EDID), including the one or more data blocks, to the source device and via the HDMI cable assembly, wherein:
the EDID includes one or more data blocks that indicates one or more advanced features of the sink device, and
the one or more advanced features support displaying of the video content in response to the signal.

2. The method of claim 1, further comprising:
receiving the video content from the source device in a format defined by the advanced features; and
displaying the video content on a display of the sink device in the format defined by the advanced features.

3. The method of claim 1, wherein the advanced features indicate an ultra-high definition (UHD) specific format.

4. The method of claim 1, wherein the source device and the sink device are connected using the HDMI cable assembly.

5. The method of claim 2, wherein the signal and the video content are received over the HDMI cable assembly.

6. The method of claim 1, wherein the sink device is ultra-high definition alliance specified reference mode (UHDA-SRM) compliant.

7. The method of claim 1, wherein the source device is at least one of a Blu-ray disc, a digital versatile disc (DVD), a set-top box or an over-the-top box.

8. The method of claim 1, wherein the sink device includes a display that comprises at least one of a television or a PC monitor.

9. A sink device to display video content, comprising:
a receiver configured to receive a signal from a source device to confirm connection of a High-Definition Multimedia Interface (HDMI) cable assembly, the signal received on a first line of the HDMI cable assembly; and
a transmitter configured to send extended display identification data (EDID), including one or more data blocks, wherein the EDID includes one or more data blocks that indicates one or more advanced features of the sink device, wherein the one or more advanced features support displaying of the video content in response to the signal, the one or more advanced features.to the source device, from a second line of the HDMI cable assembly.

10. The sink device of claim 9, further comprising:
the receiver configured to receive the video content from the source device in a format defined by the advanced features; and
a display configured to display the video content on a display of the sink device in the format defined by the advanced features.

11. The sink device of claim 9, wherein the advanced features indicate the format to be an ultra-high definition (UHD) specific format.

12. The sink device of claim 11, wherein the source device and the sink device are connected using the HDMI cable assembly.

13. The sink device of claim 12, wherein the signal and the video content are received over the HDMI cable assembly.

14. The sink device of claim 9, wherein the sink device is ultra-high definition alliance specified reference mode (UHDA-SRM) compliant.

15. The sink device of claim 9, wherein the source device is at least one of a Blu-ray disc, a digital versatile disc (DVD), a set-top box or an over-the-top box.

16. The sink device of claim 9, wherein the display comprises at least one of a television or a PC monitor.

17. The sink device of claim 9, wherein the first line of the HDMI cable assembly is a +5V/Hot Plug Detect (HPD) line and the second line of the HDMI cable assembly is a Display Data Channel (DDC) line.
